(19) United States
(12) Patent Application Publication
(10) Pub. No.: US 2026/0213943 A1
(43) Pub. Date: Jul. 23, 2026

(54) INTER-FORMAT ENCRYPTION OF DATA INDEPENDENT OF AN ENCRYPTION AND A DECRYPTION KEY

(71) Applicant: Cerner Innovation, Inc., Kansas City, MO (US)

(72) Inventors: Praveen Bhat Gurpur, Karnataka (IN); Winston Rohan Dsouza, Melbourne (AU)

(73) Assignee: Cerner Innovation, Inc., Kansas City, MO (US)

(21) Appl. No.: 19/266,045

(22) Filed: Jul. 10, 2025

Related U.S. Application Data
(60) Provisional application No. 63/746,702, filed on Jan. 17, 2025.

(51) Int. Cl. H04L 9/32; G06N 20/20

(52) U.S. Cl. CPC H04L 9/32; G06N 20/20

(57) ABSTRACT

The present disclosure relates to encryption techniques, leveraging inter-format conversions for encrypting input data. These techniques enable keyless encryption and decryption, independent of traditional encryption or decryption keys. The input data that corresponds to any digital format (such as audio, text, or image) undergoes one or more inter-format conversions during both encryption and decryption processes. The first inter-format conversion involves applying one or more transformations to the input data, generating encrypted data in a first digital format. A second inter-format conversion may then be applied to the encrypted data through modeling or other transformations, resulting in a secondary encrypted representation in a second digital format. During decryption, inverse encryption logic is used to reverse the process, applied either to the encrypted data or the secondary encrypted representation. This enables restoration of the original input data, providing a secure and keyless method of encryption and decryption across different digital formats.

### CROSS-REFERENCE TO RELATED APPLICATIONS

This application claims the benefit of and the priority to U.S. Provisional Patent Application No. 63/746,702, filed on Jan. 17, 2025, which is hereby incorporated by reference in its entirety for all purposes.

### BACKGROUND

With rapid growth of digital users worldwide, data breaching incidents have become more frequent and severe. Such incidents may pose significant risks to privacy, reputation, personal identity, and huge financial losses. Every year, thousands of cyberattacks and data breaching incidents occur globally, leading to devastating consequences for individuals, businesses, and governments alike. These incidents may highlight a concern for more robust methods of data protection of sensitive data such as medical, financial, government, law-enforcement, national security, and military data. Effective encryption methods contribute to secure transmission, processing, and storage of sensitive information. Powerful encryption technologies may employ multiple layers of security, including confidentiality, data integrity, authentication, and compliance with legal and regulatory standards. As cyber threats evolve, there is an ever-growing demand for innovative encryption solutions to safeguard against data breaches and mitigate the risks associated with these attacks.

Another significant risk in securing sensitive data from data breaches may be the improper use or management of keys in a communication network. If the information is sent over an insecure communication network, the keys may get exposed during the encryption or decryption process, resulting in data privacy threat for other data streams passing through the communication network. Additionally, improper management of keys may lead to problems such as unauthorized access or a loss of keys, making backup or restoration challenging. In extreme situations, this may lead to permanent inaccessibility of the encrypted data. In addition to these factors, if the encryption keys are used for too long without a periodic change, the keys may become more vulnerable to data breaching incidents.

### SUMMARY

Certain aspects and features of the present disclosure relate to techniques for generating encrypted data by leveraging encryption logic that includes one or more inter-format conversions, independent of an encryption key. In the disclosed techniques, the encryption logic may be used to encrypt input data, and a reverse processing of the encryption logic may serve as decryption logic to decrypt the encrypted data. The input data may correspond to any digital format of one or more digital formats (e.g., text, image, audio, or video). The encrypted data in a digital format may be generated by performing the one or more inter-format conversions on the input data. The one or more inter-format conversions may include preprocessing the input data, involving one or more transformations (or a series of transformations). The one or more transformations may be applied based on the (type of) digital format of the input data, which differs from the first digital format. For example, the encrypted data for the input data including textual data may comprise shorthand encrypted data, followed by a two-dimensional (2D) matrix that may represent an image format obtained by applying one or more numeric conversions (or numeric-encoding) and a reshaping operation to the shorthand encrypted data.

Similarly, for the input data including an image, a character-encoded vector transformation and the reshaping operation may be applied to each row, column and/or dimension of the image resulting in a one-dimensional (1D) textual format. Alternatively, for the input data including audio data, a quantized 1D vector and a series of numeric conversions such as decimal to octal, octal to binary and binary to ASCII conversions may be applied, generating a 1D character-encoded vector representing the textual format. In some examples, the encrypted data including the audio data may include a matrix representation representing an image that may be generated from the 1D quantized vector e.g., by applying short-time Fourier transform (STFT) or other matrix operations such as reshaping. It may be understood that a sequence of applying one or more transformations may vary.

In some aspects of the present disclosure, the one or more inter-format conversions applied to generate the encrypted data further include generating a secondary encrypted representation in a second digital format that differs from the first digital format by modeling the encrypted data. In some examples, the modeling may include applying one or more machine-learning models that are configured to non-linearly map the encrypted data from the first digital format to the second digital format. The mapping may correspond to a specific statistical distribution such as Gaussian, Laplacian, or a noise-related distribution. For example, the one or more machine-learning models may include an encoder, such as a variational autoencoder (VAE) or a generative adversarial network (GAN) that may be configured to model this inter-format conversion, thereby generating the secondary encrypted representation. The secondary encrypted representation is generated based on the first digital format maintain the inter-format conversion so that the second digital format is different from the first digital format.

For example, when the first digital format is the image format, the encoder may be configured to map the image data to an abstract audio format, where the secondary encrypted representation corresponds to a spectral or audio representation. Similarly, when the first digital format is the textual format, the encoder may be configured to generate a different digital format such as an abstract image or the abstract audio, depending upon the first digital format. The encrypted data may then be transmitted to a receiver over a network, backed up or securely stored in a database for further processing. In some examples, the encrypted data undergoes decryption through the decryption logic that is independent of the decryption key, resulting in decrypted data that corresponds to the input data.

In one example, the one or more inter-format conversions further include generating secondary encrypted representation in the second digital format (i.e., an abstract audio) by processing the encrypted data in the first digital format (i.e., the image format). The processing may include mapping one or more parameters of the first digital format of the encrypted data to one or more parameters of the second digital format. For example, mapping one or more matrix or image parameters (such as cell values, spatial layout, contrast, or any combination thereof) to one or more audio parameters (e.g., frequency, amplitude, phase, angle, or temporal characteristics or any combination thereof). In one aspect of the present disclosure, the mapping may be carried out by direct mapping (i.e., straightforward association between both the parameters) or by sonification (i.e., introducing auditory elements) for adding complexity, thereby enhancing the interpretative experience by engaging multiple senses in a different domain. This domain may include a frequency domain, wavelet domain, cepstral domain or any domain that may be represented as a mathematical function.

It may be understood that the inter-format conversions may be applied iteratively in any sequence. For example, for textual input data, the first inter-format conversion may include text-to-audio (e.g., by applying one or more machine-learning models) and a second inter-format conversion may include audio-to-image (e.g., by applying one or more transformations or by taking an STFT). Continuing these inter-format conversions, a third inter-format conversion may include image-to-text (e.g., by applying the one or more transformations) and so on.

The encrypted data may be decrypted independent of the decryption key by executing the decryption logic that includes the one or more inter-format conversions applied to the encrypted data in reverse order of the encryption logic to retrieve the (original) input data. In some examples, the decryption logic includes decrypting the secondary encrypted representation to generate the encrypted data in the first digital format using a decoder of the one or more machine-learning models, e.g., generating the 2D matrix representing the image format or the 1D character-encoded vector representing the textual format as the first digital format. Additionally, or alternatively, the decryption logic includes generating decrypted data that corresponds to the input data by applying one or more reverse transformations. Furthermore, the decryption logic may include executing numeric-encoding, character-encoding, matrix, or vector transformations (e.g., rescaling or normalizing, reshaping, concatenation, complementing, transposing or other similar transformations), shorthand transformation, mathematical or statistical transformations in between the conversions.

In certain aspects, a modifying parameter, such as a transformation variable or a function of the transformation variable, may be introduced into the encryption logic during the execution of inter-format conversions (or series of operations). For example, during the first inter-format conversion (i.e., generating encrypted data), a transformation variable p may be incorporated prior to, during, or subsequent to the first inter-format conversion, contributing to a (small) modification to the encrypted data. This transformation may be applied progressively with each successive inter-format conversion in the operation sequence, thereby adding additional layers of encryption. Over successive conversions, the progressive transformation may cause the (resulting) encrypted data to become increasingly distorted, to the extent that, upon completion of the encryption logic, the encrypted data appears substantially different from the original input data.

By leveraging the encryption disclosed techniques, the resulting encrypted data may be difficult to decrypt. Only the intended receiver, equipped with the correct pattern and sequence involved in encryption/decryption logic, may decrypt the encrypted data. By executing the one or more inter-format conversions in reverse order, the modifying parameter may be progressively removed at each inter-format conversion of the decryption logic. This approach may enable the security of the input data e.g., in communication process by safeguarding the data from potential breaches, reducing the risks of unauthorized access or data leakage. By encrypting the data during transmission, at rest, storage, and other phases such as data processing or backup, it remains protected from external threats, thereby providing the confidentiality and integrity of sensitive information.

In some embodiments, a system is provided that includes one or more data processors and a non-transitory computer readable storage medium containing instruction which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 shows an exemplary block diagram to illustrate data flow between a sender and a receiver including a network for an inter-format encryption and decryption in accordance with some aspects of the present disclosure.

FIG. 2 illustrates an exemplary block diagram showing a process flow of the inter-format encryption including various inter-format conversions of input data in encryption logic.

FIG. 3 illustrates a block diagram to encrypt the input data in accordance with some aspects of the present disclosure.

FIG. 4 illustrates a block diagram showing preprocessing of the input data including image data to generate encrypted data in accordance with some aspects of the present disclosure.

FIG. 5 illustrates an exemplary workflow for the inter-format encryption of the input data using some aspects of the present disclosure.

FIG. 6 depicts a simplified diagram of a distributed system for implementing an aspect of the present disclosure.

FIG. 7 is a simplified block diagram of a cloud-based system environment in accordance with certain aspects of various embodiments of the invention.

FIG. 8 illustrates an exemplary computer system that may be used to implement certain aspects of the present disclosure.

### DETAILED DESCRIPTION

The present disclosure relates to multi-layer encryption techniques for encrypting input data by leveraging one or more inter-format conversions. The techniques, as disclosed herein, may provide a keyless encryption, independent of an encryption and a decryption key, for the input data in a digital format (e.g., audio, image, text, video). The inter-format conversions, employed within encryption and decryption, may involve transforming the input data (or encrypted data during decryption) from one digital format to another or to a different representation incorporating multi-layer encryption. The inter-format conversions may utilize a combination of encoding techniques (e.g., numeric-encoding or character-encoding), arithmetic transformations (e.g., incorporating a modifying parameter), vectors or matrix operations (e.g., transposing, complementing, reshaping, normalization, etc.) and/or machine-learning techniques for each inter-format conversion. For example, encryption logic may include preprocessing the input data by applying one or more transformations, based on (type of) the digital format of the input data, to generate encrypted data. The encrypted data may be associated with a first digital format, which may differ from the digital format of the input data.

In some other examples, the inter-format conversion may further include modeling the encrypted data non-linearly by applying one or more machine-learning techniques, resulting in generation of a secondary encrypted representation in a second digital format. It may be appreciated that the second digital format may be different from the first digital format. Upon encryption of the input data, decryption logic may be configured that corresponds to an inverse of the encryption logic that is applied to the encrypted data to restore the input data.

Traditionally, an encryption algorithm employs an encryption key and a decryption key, where a combination of both enables data security. The encryption key is used to transform the input data into encrypted data, enabling only authorized recipients, equipped with the corresponding decryption key, to decrypt and access the input information. The combination of both keys is aimed at adding variability and complexity to the encryption techniques, to avoid unauthorized access. Since the original input data may be retrieved by decrypting the encrypted data using the decryption key, there may be a threat of data breach, if the decryption key or private key (for asymmetric encryption) is exposed or mismanaged.

The present disclosure introduces a multi-layer encryption approach through the inter-format conversions and the subsequent modeling, applicable to various digital formats, including audio, image, text, and video. Unlike traditional encryption methods that rely on encryption and decryption keys, these approaches eliminate the use of such keys. By applying mathematical and statistical transformations to the input data, it may be converted into different digital formats or representations, maintaining the confidentiality and security of the input data without key-based decryption. The disclosed techniques may provide adaptability, as these techniques can be applied to a wide range of digital formats, providing a flexible solution for diverse use cases. Additionally, the encryption techniques can be adjusted to accommodate changes in data characteristics or formats, enhancing its scalability. The absence of a key may also provide resilience to attacks, as there is no central point of vulnerability commonly associated with key management in traditional encryption systems.

Additionally, the inter-format conversions in reverse order including multiple digital formats may function as the decryption logic independent of the decryption key, involving a combination of various numeric-encodings, character-encodings, statistical, and/or modeling-based transformations to reconstruct the input data. These inter-formats can encompass a variety of digital formats for data processing that can be configured in any sequence to enhance complexity of the data retrieval. This sequence may be constructed to hinder the efforts of any unauthorized party attempting to intercept or decipher the underlying decryption logic. Beyond simple format conversion, the disclosed techniques incorporate multiple layers of encryption, data processing, arithmetic, and machine-learning-based (non-linear) modeling that may significantly amplify the complexity of retrieval.

In certain aspects, a modifying parameter, such as a transformation variable or a function of the transformation variable, may be integrated into the encryption logic during the execution of inter-format conversions (or a sequence of operations). For instance, during the initial inter-format encryption (i.e., the generation of the encrypted data), a transformation variable p may be introduced either before, during, or after the first inter-format conversion, leading to a slight modification of the encrypted data. This transformation may be applied progressively in each inter-format conversion in the sequence, adding additional encryption layers. Over multiple encryption operations, this progressive modification may gradually distort the encrypted data, appearing different from the original input data once the encryption sequence is completed.

For example, a modifying parameter p may be arithmetically added or multiplied to the input data prior to, during or subsequent to the generation of encrypted data. Initially, the encrypted data may be altered by a small factor e.g., p, which modifies the input data slightly. As each encryption layer (including the inter-format conversion) is applied, the modification may compound, distorting the original data further. By the end of the encryption process, the resulting data may appear largely different from the original information, making it challenging to interpret without knowing the modifying parameter, its corresponding arithmetic manipulation, sequence and pattern of encryption. The intended recipient, equipped with the modifying parameter, specific pattern and sequence of operations used during encryption, may reverse the process to retrieve the original data. By executing the decryption logic in reverse order, the modifying parameter may be progressively removed at each inter-format conversion, restoring the original data.

In one aspect of the present disclosure, the input data may include textual data, including plain text, RTF (rich text format), HTML, CSV, JSON, or XML. To facilitate further processing, the input data may first be converted into a standardized form such as plain text, through appropriate transformations. For example, HTML or XML data may be parsed to extract textual content while discarding any tags, attributes, or metadata. CSV and JSON data may be converted into plain text by processing the structured data into a readable format, preserving only the relevant text information. Once in plain text form, the inter-format conversions may be applied to the textual data. For example, the textual data may be converted into the encrypted data in the first digital format that corresponds to an audio format or an image format by applying one or more transformations.

The series of transformations (or none or more transformations) may be applied depending on the specific digital format of the input data. For example, textual data may undergo transformations that may involve arithmetically incorporating the modifying parameter, applying numeric conversions (interchangeably used herein with numeric-encodings), such as converting ASCII characters into decimal or binary representations, resulting in encoded numeric data. Alternatively, the textual data may first be encoded into a shorthand encrypted format followed by the modifying parameter and/or numeric conversions. The shorthand encrypted format may include e.g., Pitman, Chandler, Current, Gregg, or Teeline, which involves representing characters, words or phrases with symbols or abbreviations to further obscure the original input data. It may be understood that one or more transformations may be applied in any order.

The series of transformations may further include transforming the encoded numeric data (i.e., one-dimensional data) into a two-dimensional (2D) matrix representing an image format to facilitate subsequent generation of the encrypted data. For example, the encoded numeric representation may be reshaped into the 2D matrix, where the first digital format may correspond to the image format. In some other examples, the encrypted data may be modeled non-linearly thereby applying an additional inter-format conversion that corresponds to the secondary encrypted representation. Similar to the first inter-format conversion, the modifying parameter may be applied arithmetically (e.g., by adding or subtracting) prior to, or subsequent to the modeling. The modeling may involve applying one or more machine-learning techniques including an encoder. The encoder may be configured to generate the encrypted data in the second digital format from the encrypted data in the first digital format, while maintaining the characteristics and nuances of the original (encrypted) data. It may be understood that these transformations may remain reversible, enabling decryption of the encrypted data back into the encrypted data corresponding to the first digital format.

For example, the one or more machine-learning models (or techniques) may include a first generative adversarial network (GAN) serving as an encoder, which may be configured to map the encrypted data from the first digital format to the secondary encrypted representation in the second digital format. The first GAN may include a generator that may transform the encrypted data into the target format (e.g., audio, if the first digital format is an image or text), while a discriminator judges whether the generated encrypted data follows a targeted distribution of the second format. For instance, when the first digital format is an image, the first GAN (encoder) may be configured to generate an encrypted audio representation by learning a transformation from image pixels to corresponding audio features, such as spectrograms or waveforms. In this process, the generator of the first GAN may learn to encode the image data into a form that represents its features in the target audio domain.

Unlike traditional systems that rely on encrypted identifiers tied to PHI or use static cryptographic keys for decryption, the admission pass in the present invention functions without requiring real-time decryption using static keys. This architecture reduces the attack surface associated with symmetric or asymmetric key exposure. In anticipation of evolving cybersecurity threats, including those posed by quantum computing, the system architecture is compatible with quantum-resistant cryptographic standards. The admission token may be generated or validated using lattice-based encryption schemes, such as CRYSTALS-Kyber for establishing secure communication channels and CRYSTALS-Dilithium for signature verification. These schemes offer computational hardness assumptions believed to be resistant to both classical and quantum attacks. Additional post-quantum algorithms, such as BIKE, NTRU, and FALCON, may be integrated to suit specific deployment needs or performance profiles. As the system avoids reliance on traditional decryption key exchanges, it offers an inherently robust foundation that supports future adoption of post-quantum encryption standards and compliance with upcoming cryptographic regulations. This ensures that the admission token remains secure and tamper-resistant, even in the face of quantum-enabled adversarial models.

It may be understood that the second digital format may correspond to an abstract format such as an abstract audio, which may not be a specific sound or real-world audio, but rather synthesized audio corresponding to a probabilistic distribution, such as a Gaussian distribution, Laplacian distribution, or a noise-related distribution. The target audio signal may be modeled as a random signal drawn from these distributions, representing the secondary encrypted representation in the abstract format that encodes the information from the first format in a hidden manner.

The one or more machine-learning models may further include a second GAN, which serves as a decoder and is configured to map the secondary encrypted representation from the second digital format (e.g., audio) back to the first digital format (e.g., image). Both GANs may use a cycle-consistency loss so that when the encrypted data is mapped back to the encrypted data, the original features of the first digital format are accurately reconstructed. This cycle consistency may provide that the transformation between the two formats is reversible, enabling reliable decryption. Thus, the first GAN generates the secondary encrypted representation in the second format (e.g., audio), and the second GAN enables decryption by reconstructing the original data (e.g., the encrypted data in image or text format) from the secondary encrypted representation. The cycle-consistency may provide a close resemblance between the recovered data to the original encrypted data, preserving the characteristics of the first digital format.

In one example, the encrypted data associated with the first digital format (e.g., image format) may be modeled by directly mapping it into a different domain, such as the frequency domain, wavelet domain, or cepstral domain, to generate the secondary encrypted representation. These mappings can be performed using various models or algorithms, including statistical methods (e.g., Fourier transform) or machine-learning techniques (e.g., linear regression, polynomial regression, ridge or lasso regression, or deep learning-based neural networks). This modeling of the generated audio may facilitate enhanced data encryption, adding complexity to the transformation process and increasing the difficulty of unauthorized data interpretation. The mapping may include, for example mapping location of a cell in the 2D matrix or the image that corresponds to the encrypted data, to corresponding parameters of the audio format such as time, frequency, amplitude, and spatial positioning. In one example, the rows and columns of the matrix may represent different time frames in the audio, with each cell influencing the amplitude, triggering an event, or introducing silence based on its value. For the numeric 2D matrix, these values may represent a range of amplitude variations rather than just binary ‘1’ or ‘0’. The matrix positions may also be mapped to specific frequency ranges, with higher values corresponding to higher frequencies and lower values to lower frequencies. Additionally, values in the matrix or intensities of the image may affect the audio's amplitude, where larger values may represent louder sounds and smaller values quieter sounds.

In the context of stereo audio, the matrix cells (or image intensities) may be mapped to left or right channels, enabling the distribution of the encoded data across the stereo field. This approach may enable the embedding of encoded numeric data within the audio format while maintaining its integrity and preserving the characteristics of the original audio signal. The multiple transformations involved may add layers of complexity and security, making it more challenging for unauthorized parties to interpret the data. In some examples, the encrypted data may occupy more space than the original input data.

Alternatively, each row or column of the 2D matrix may generate a sequence of audio samples, which may be then combined to form the audio format. Another approach may involve mapping image parameters to audio parameters through sonification, linking characteristics of the 2D matrix (that may also be viewed as an image) such as contrast, brightness, and edges to audio features e.g., time, pitch, duration, and dynamic level. For instance, the horizontal position of elements in the matrix (rows or columns) may correspond to time, determining when a note starts. The numeric value representing intensity or brightness in the matrix could be mapped to pitch, with higher values producing higher pitches. Similarly, specific numeric values may control note duration or dynamic level, with larger values resulting in longer notes or louder sounds. This sonification approach may transform numeric or image-based data into a distinct auditory experience, uncovering patterns that might be missed in traditional visual formats. By mapping the encoded numeric data, representing the encrypted data, to sound, it may create a multidimensional interpretation of the data, enhancing its security and understanding.

In one aspect of the present disclosure, the input data may include image data in various formats, such as JPEG, PNG, GIF, SVG, or EMP. The inter-format conversion of the image data may involve applying transformations to convert the image data into the encrypted data in the first digital format (e.g., audio or text). For example, for image-to-text conversion, the transformations may include adding or multiplying the modifying parameter to the image data prior to, during, or subsequent to, numeric conversions (or numeric-encodings) and/or applying character-encoding (e.g., ASCII) to the rows or columns of the 2D or 3D image. The resulting encrypted data may correspond to a textual format as a first digital format. In some examples, the encrypted data may undergo another inter-format conversion i.e., (image-to-text or image-to-audio) to (text-to-audio or audio-to-text) by employing subsequent modeling, and arithmetic incorporation of the modifying parameter, similar to the input including textual data. For feeding into an ML model, the textual data may be encoded into a numerical or embedding-based representation. This encrypted data corresponding to the textual (and subsequent numerical) format may then be processed using the one or more machine-learning techniques, such as a variational autoencoder (VAE) or the GAN as encoders, to model the transformation into the secondary encrypted representation in the second digital format, such as abstract audio or other encoded forms. Since image data can be flattened into a one-dimensional format (that may also correspond to time-series audio format), the same ML techniques can be used for image, audio and text inputs, enabling unified processing through a shared latent space that provides conversion from both formats into encrypted audio representations.

In another aspect of the present disclosure, the input data may include audio data in various audio formats, including MP3, WAV, or M4A. An encoded numeric vector, as encrypted data, from the audio data may be generated by applying one or more transformations e.g., quantization, followed by the incorporation of the modifying parameters and the numeric conversions such as octal, binary, and/or ASCII, representing a textual format as the first digital format. Alternatively, the quantized vector may be applied with short-time Fourier transform (STFT) or a simple reshaping of the 1D vector (audio time series data) into rows and columns to generate an image. This encrypted data may further be processed by applying the modifying parameter and modeling (similar to the image and textual input data) by the one or more ML techniques, generating the secondary encrypted representation in the second digital format. For example, the first inter-format conversion for audio data may include audio-to-text or audio-to-image by applying one or more transformations. Similarly, the second inter-format conversion may involve format conversions such as text-to-image or image-to-text, maintaining that each pair of consecutive formats during the conversions remain distinct from one another.

For the decryption process, the encryption logic may be executed in reverse order of encryption, i.e., from secondary encrypted representation to encrypted data and then to input data, or alternatively, from the encrypted data of the input data. The decryption logic may be independent of the decryption key. It should be understood that if the results of these inter-format conversions are manipulated during encryption using a modifying parameter, the reverse arithmetic operations are applied in a similar manner following a reverse order to decrypt the data. For example, during decryption, the decrypted data may be reconstructed by applying the one or more reverse transformations including the removal of modifying parameter by applying reverse arithmetic. This means that if, e.g., the modifying parameter was set to a constant value of ‘5’ that is arithmetically added to the input data prior to or subsequent to the first inter-format conversion, then after applying the reverse transformations, ‘5’ is subtracted from the input data.

Similarly, if other inter-format conversions and/or manipulation by the modifying parameter is performed during encryption, same inter-format conversions and manipulation are applied in reverse order. For example, if sonification was used for encryption, a reverse sonification process may be performed and if frequency-domain transformations were applied during encryption, the reverse transformation may be used to reconstruct the (original) input data. This reversal of transformations may enable that the encrypted data can be accurately recovered and interpreted, preserving the integrity of the original input data. Alternatively, or additionally, the decrypted data may be generated by processing the secondary encrypted representation by leveraging the one or more machine-learning models e.g., a decoder or the second generative adversarial network (GAN). These techniques may perform accurate inversion of the one or more parameters, enabling the restoration of the encrypted data by reverse mapping the relevant parameters. While the present invention has been specifically disclosed through embodiments and optional features, the input data may also include video data, which can be viewed as a sequence of images accompanying audio data. This variation, being apparent to those skilled in the art, falls within the scope of the invention as defined by the appended claims.

The disclosed techniques may take more data storage space to encrypt or decrypt data. So, various properties of the communication channel (e.g., bandwidth, latency, and memory) may be adjusted accordingly. However, considering the level of security provided by the disclosed encryption techniques, the data storage space may not be considered as a constraint. As a result, the disclosed techniques can meet a wide range of international regulations, including GDPR (General Data Protection Regulation), HIPAA (Health Insurance Portability and Accountability Act), and PCI-DSS (Payment Card Industry Data Security Standard). The disclosed multilayer encryption techniques may contribute to safeguarding sensitive data across industries such as healthcare, finance, government, law enforcement, national security, and the military, protecting both customer and organizational information. These encryption techniques may be particularly utilized for sensitive and secure data, where space may not be the main concern for various stages of data processing. Since the techniques discussed herein may provide secure data for multiple formats, various customers, multiple industries including healthcare, fintech, medical, financial, government, law-enforcement, national security or military and different organizations may employ the disclosed encryption techniques for data security.

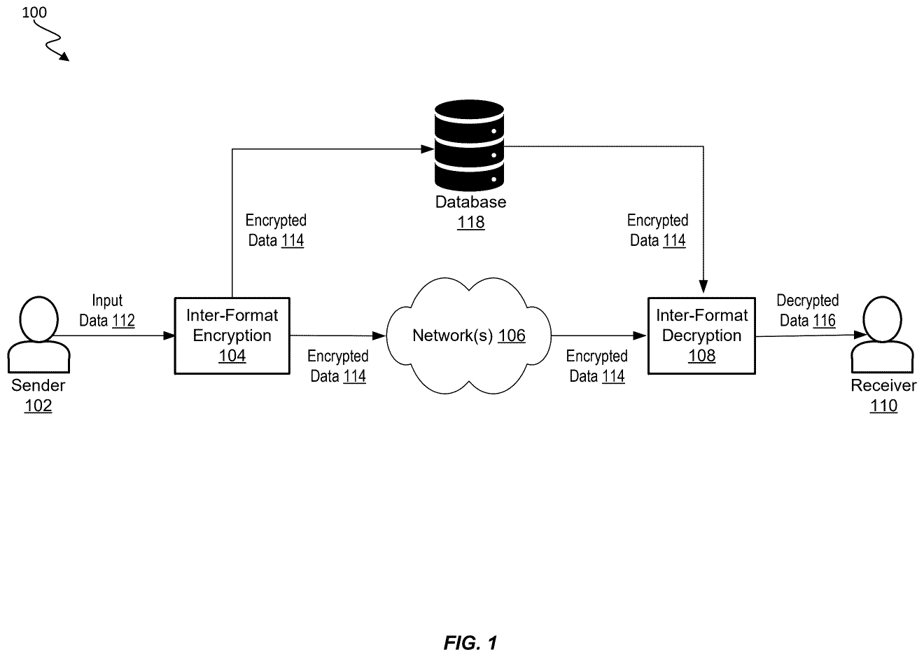

FIG. 1 illustrates an exemplary overview 100 of one or more applications of data encryption techniques in accordance with some aspects of the present disclosure. The applications for data encryption may include e.g., secure data transmission, such as encrypting communications over the internet (e.g., HTTPS), protecting sensitive information in storage (e.g., encrypting files or databases), and securing data access in cloud services for privacy and preventing unauthorized access. These techniques may also be applied to encrypt multimedia data, including audio, video, and image files, to protect intellectual property and user data. For example, a secure communication network, as shown in FIG. 1, may include a sender 102, an inter-format encryption 104, a network 106, a database 118, an inter-format decryption 108 and a receiver 110. The sender 102 may send input data 112 corresponding to any digital format (e.g., text, image, audio, or video) to the inter-format encryption 104 for generating encrypted data 114. The inter-format encryption 104 may transform the input data 112 into one or more digital formats (e.g., text to image, image to audio, video to a set of images and audio) by incorporating one or more intermediate mathematical or statistical processes.

Notably, the inter-format encryption 104 may be performed independent of an encryption key to generate the encrypted data 114, making it a secure encryption. The encrypted data 114 may be stored to the database 118 or sent to the receiver 110 over the network 106 or to the cloud service for future access and utilization. The encrypted data 114 may be processed by the inter-format decryption 108 to generate decrypted data 116 by applying a decryption logic. The decryption logic may include reversing the inter-format conversions along with incorporating one or more reverse intermediate mathematical or statistical processing similar to those applied during encryption. The decrypted data 116 may correspond to the input data 112 and may be sent to the receiver 110.

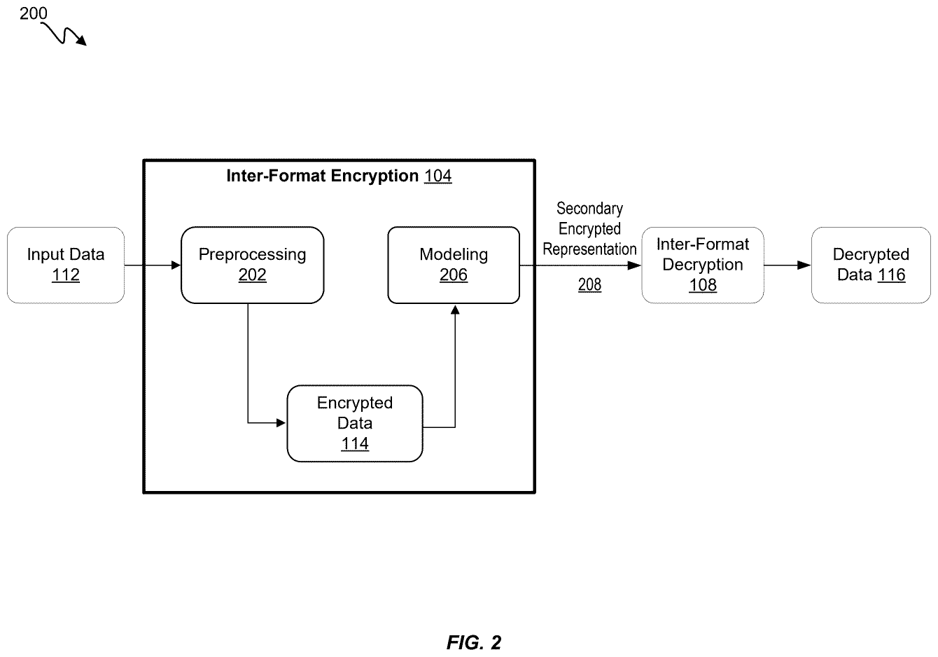

FIG. 2 illustrates an exemplary block diagram of 200, showing the inter-format encryption 104 of the input data 112 to generate the encrypted data 114. The inter-format encryption 104 may include preprocessing 202 the input data 112 for generating a encrypted data 114 in a first digital format. In one aspect of the present disclosure, the input data may include textual information, where the preprocessing 202 may include applying one or more transformations e.g., introducing modifying parameter, numeric conversions between different numeral systems, including ASCII (American Standard Code for Information Interchange), binary, decimal, hexadecimal, octal, or others, generating numeric encoded data.

For example, the letter ‘A’ (which may be represented by the decimal value 65) may first have a modifying parameter applied, such as adding 5 to its numeric value, resulting in 70. This modified value can then be converted into a different format, such as: in hexadecimal as 0×46, in octal as 106, or in binary as 01000110, corresponding to the numeric encoded data. Alternatively, for generating the encrypted data, the one or more transformations may include encoding the textual data into a shorthand encrypted format (e.g., Pitman, Chandler, Current, Gregg, or Teeline) followed by the numeric conversions (e.g., Unicode, ASCII, incorporating the modifying parameter, or binary) that correspond to the modified numeric encoded data, and a rearrangement into a two-dimensional (2D) matrix representation that may correspond to an image format.

In some other examples, the input data 112 may include image data in various formats, such as JPEG, PNG, GIF, SVG, or EMP. The first inter-format conversion from the image data (i.e., 204) may involve one or more transformations, such as incorporating the modifying parameter, applying character-encoding (e.g., ASCII or extended ASCII) to the rows or columns of the 2D or 3D image, generating textual data as the first digital format. These transformations may be followed by a conversion into the encoded numeric data for the subsequent modifying parameter, modeling and processing of the text by the one or more machine-learning models. Alternatively, the input data 112 may include audio data in various audio formats, including MP3, WAV, M4A, FLAC, a quantized 1D vector, arithmetically incorporating modifying parameter, and a subsequent matrix representation that may be generated as the encrypted data 114.

In one aspect of the present disclosure, the generated encrypted data 114 may be transformed by modeling 206 to generate a secondary encrypted representation 208 in a second digital format. In one aspect of the current disclosure, the modeling may include applying one or more machine-learning models including an encoder that may be configured to map the first digital format to the second digital format. In some examples, the encrypted data 114 may be transformed for the image and text-based first digital format through modeling 206 to an audio domain resulting in generation of the secondary encrypted representation 208. The audio domain may be a frequency domain, a wavelet domain, or a cepstral domain using various models or algorithms, including statistical methods (e.g., Fourier transform) or machine-learning techniques (e.g., linear regression, polynomial regression, ridge or lasso regression, or deep learning-based neural networks). The encrypted data 114 or the secondary encrypted representation 208 may then be passed through inter-format decryption 108 to generate the decrypted data 116 that corresponds to the input data 112 after various inter-format conversion in multiple digital formats.

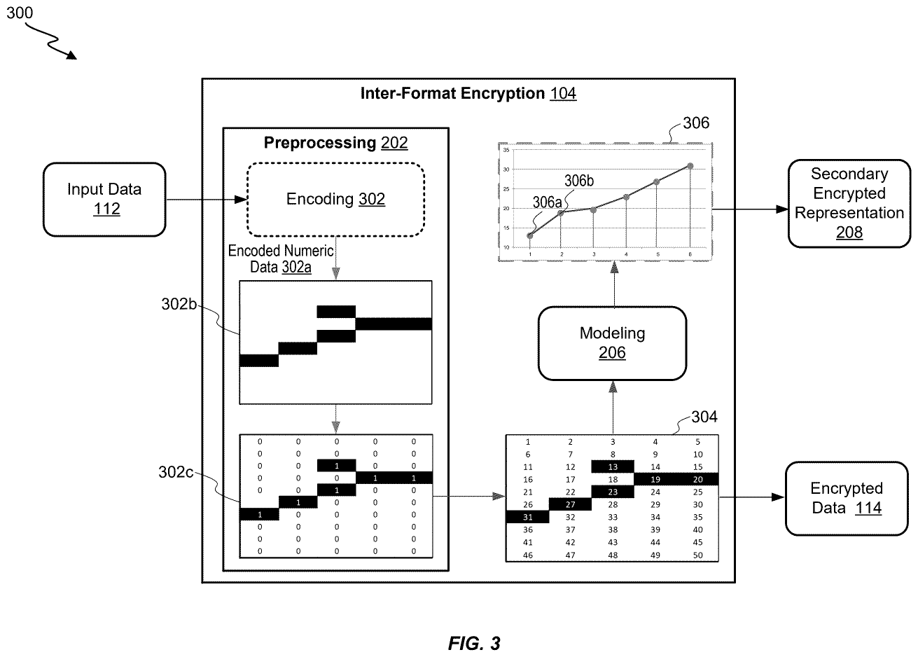

FIG. 3 illustrates an exemplary block diagram 300 showing inter-format encryption 104 of the input data 112 to generate the encrypted data 114 using some aspects of the present disclosure. The inter-format encryption 104 may include one or more inter-format conversions. The first inter-format conversion may involve transformations including a combination of various numerical, arithmetic (e.g., incorporating modifying parameter), statistical transformations, vector, and matrix operations. The input data 112 may undergo preprocessing 202 to generate encrypted data 114 in a first digital format. Preprocessing 202 may apply one or more transformations, including encoding 302 to generate encoded numeric data 302a. For example, the input data 112 corresponding to a textual format may undergo one or more transformations that may involve numeric conversions, such as converting ASCII characters into decimal or binary representations, multiplying or adding the modifying parameter, resulting in the encoded numeric data 302a. Alternatively, the textual data may first be encoded into a shorthand encrypted format followed by the numeric conversions and the introduction of the modifying parameter. The shorthand encrypted format may include e.g., Pitman, Chandler, Current, Gregg, or Teeline, which involves representing words or phrases with symbols or abbreviations to further obscure the original input data that may also facilitate compression, transcription and note-taking for rapidity and conciseness.

For example, input data 112 including textual data, such as the string “Hello World,” may undergo a series of transformations while encoding 302 to generate an encoded numeric data 302 suitable for encryption. Initially, the textual data may be encoded using a shorthand encryption system (e.g., Pitman, Teeline, Gregg, or Current). In this transformation, each character, word, or phrase may be represented by corresponding shorthand symbols. For example, the word “Hello” may be encoded as the shorthand symbol “ [symbol] ” (Pitman shorthand), and “World” may be encoded as the symbol “∫” (Teeline shorthand), which may represent the entire words in abbreviated forms, reducing the data size and further encrypting the original input data. Following the shorthand encryption, the characters of the shorthand symbols (or the original text, depending on the approach) may then be transformed into a numeric representation using the ASCII encoding scheme.

Each character in the shorthand symbols or the original text may be mapped to its corresponding ASCII value. For example, the shorthand symbols may be mapped to their respective Unicode code points. The symbol “ [symbol] ”, representing “Hello”, has a Unicode value of U+2E6E, and the symbol “∫”, representing “World”, corresponds to U+222B in Unicode. If a modifying parameter of 5 is applied to these Unicode values, the values would be adjusted accordingly. For example, the Unicode value “U+2E6E” becomes U+2E73 (2E6E+5) and the Unicode value “U+222B” becomes U+2230 (222B+5). These modified Unicode code points may then be converted into their binary representations, thereby generating the encoded numeric data. The modified Unicode value “U+2E73” in hexadecimal translates to the 16-bit binary sequence 00101110 01110111 0011, while the modified Unicode value “U+2230” becomes 00100010 00110011 0000. The final binary representation, a concatenation of the two modified binary sequences from the shorthand symbols, may become: “00101110 01110111 0011 00100010 00110011 0000”. This binary data may represent the encoded numeric data 302a of the modified phrase.

This multi-conversion approach—starting with shorthand encryption, followed by Unicode mapping (with the modifying parameter applied), modifying parameter, and ending with binary conversion—adds layers of security and complexity to the data, making it difficult for unauthorized parties to decipher without access to the decryption logic.

In other examples, the character ‘H’ may be converted directly to its ASCII value of 72, ‘e’ to 101, ‘l’ to 108, etc. Once the ASCII values are obtained, these may be then converted into their binary equivalents. For instance, the ASCII value 72 for ‘H’ is represented as 01001000 in binary, 101 for ‘e’ becomes 01100101, and this process continues for each character. The complete binary encoding for the string “Hello World” may therefore be: “01001000 01100101 01101100 01101100 01101111 00100000 01010111 01101111 01110010 01101100 01100100”. This series of binary numbers represents the encoded numeric data 302a corresponding to the original textual input “Hello World” after undergoing shorthand encryption, ASCII encoding, and binary conversion. This encoded numeric data 302a may now be processed further in the encryption pipeline, facilitating secure transmission or storage. For example, the encoded numeric data 302a (that represents the binary or numeric vector) may be reshaped into the 2D matrix binary matrix 302b, a 2D complement binary matrix 302c or a transformed matrix 304, representing the encrypted data 114. These 2D matrices 302b, 302c, or 304 may correspond to the image format as the first digital format.

The encrypted data 114, denoted as e.g., 302b, 302c or 304, which corresponds to identifier 204 in FIG. 2, may be further processed by incorporating the modifying parameter prior to or subsequent to employing modeling 206 to generate the secondary encrypted representation 208 in the second digital format. In one aspect of the present disclosure, the modeling 206 may be performed by leveraging one or more machine-learning models, including an encoder, to generate the secondary encrypted representation 208 in another digital format. The modeling of the encrypted data 114 including digital formats e.g., (image or text data) into the second digital format e.g., audio may be achieved through the use of an encoder-decoder architecture. For example, a first GAN, functioning as the encoder, may be responsible for mapping the encrypted data in the first digital format (such as an image or text) into the secondary encrypted representation 208 in the second digital format (e.g., audio). The encoder may learn to effectively transform the features of the original data into an alternative format while preserving its characteristics.

The second GAN, serving as the decoder, may take this secondary encrypted representation 208 and map it back from the second digital format (e.g., audio) to the first digital format (e.g., image or text). The cycle-consistency loss helps in making the decryption process in reverse to the encryption. By imposing this loss, the techniques reduce the discrepancy between the original input and the reconstructed output so that when the encrypted data is decoded, the original features of the first digital format are accurately reconstructed. This cycle-consistency loss may enable a reversible transformation, meaning that the data can be encrypted into one format (e.g., audio) and then decrypted back into its original format (e.g., image or text) without significant loss or distortion of the data's inherent features. The first GAN generates the secondary encrypted representation 208 in the second format, and the second GAN enables the decryption process. Subsequently, the modifying parameter may be removed by applying inverse arithmetic operations to the generated encrypted data.

Ins some examples, the modeling 212 may be performed by mapping one or more parameters of the encrypted data 304, mapped from the matrix, to corresponding parameters of the audio format that may correspond to the secondary encrypted representation 208. The mapping may include, for example mapping location of a cell in the 2D matrix (e.g., where there is a binary ‘1’ or ‘0’) to corresponding parameters of the audio format such as time, frequency, amplitude, and spatial positioning. In this specific example of audio format 306, the cell locations of the encrypted data 304 are mapped to the amplitude of the audio signal e.g., position 13 of the cell is mapped to 306a and 19 is mapped at 306b.

In some aspects of the present disclosure, the input data 112 may include image data that may be preprocessed by applying one or more transformations (e.g., applying modifying parameter, character-encoded vector transformation followed by the numeric conversions) to generate the matrix representation corresponding to the encrypted data 114 (or the encrypted data 114). Alternatively, the input data 112 may comprise audio data, which may be quantized into a one-dimensional (1D) vector. For example, the input audio data may undergo quantization to convert a continuous audio signal into a discrete representation. The audio data, typically represented as a series of amplitude values over time, may first be sampled at predetermined intervals. For example, an audio signal may be sampled at a rate of 10,000 Hz, generating a series of numerical values that represent the amplitude of the audio signal at each sample point.

This continuous audio signal may be quantized by assigning each sampled amplitude to a discrete numerical value. The quantization process may involve reducing the precision of the amplitude values, such as by mapping them to a finite set of discrete levels, for instance, within an 8-bit range of values from 0 to 255. After quantization, the discrete numerical values may be organized into a one-dimensional (1D) vector, where each element in the vector corresponds to the quantized amplitude at a specific time point in the audio signal. For instance, the quantized audio data may be represented as a 1D vector of length 10,000, as illustrated by a sequence of values such as [120, 150, 90, 100, 80, 130, . . . ]. This 1D vector representation of the audio signal may serve as the encoded numeric data 302a that can be further processed (e.g., by incorporating the modifying parameter) for encryption or other transformations.

The 1D vector of quantized audio data may be transformed, in preprocessing 202, into a different format, depending on the intended processing or encryption objectives. One approach may involve reshaping the 1D vector into a two-dimensional (2D) matrix representation, which facilitates more complex transformations, such as converting it into a textual or image format as the first digital format. This reshaping process may involve reorganizing the quantized vector into rows and columns, enabling the representation of the audio data in a structured 2D grid in an image format that corresponds to the first digital format. For example, the 1D vector, comprising of 10,000 quantized elements, may be divided into a 2D matrix of dimensions such as 100 rows by 100 columns, where each matrix element corresponds to a specific quantized sample from the original audio data. The quantized 1D vector or the reshaped 2D matrix may be converted into characters representing textual data by applying character-encoding techniques (e.g., ASCII or Unicode). Alternatively, the quantized 1D vector can be processed using operations such as short-time Fourier transform (STFT) to convert the audio's time-domain data into a frequency-domain representation, enabling the spectrograms (images) to serve as the first digital format.

By leveraging structured transformations such as reshaping or character-encoding, the resulting format (whether text or image) may provide an efficient structure for further modeling, making it suitable for subsequent encryption and data manipulation. This transformed 2D matrix representation thus provides the encrypted data 114 of the original audio data, which can then be used as input for further modeling 212 or encryption techniques, offering flexibility in how the audio data is represented and processed within the encryption system.

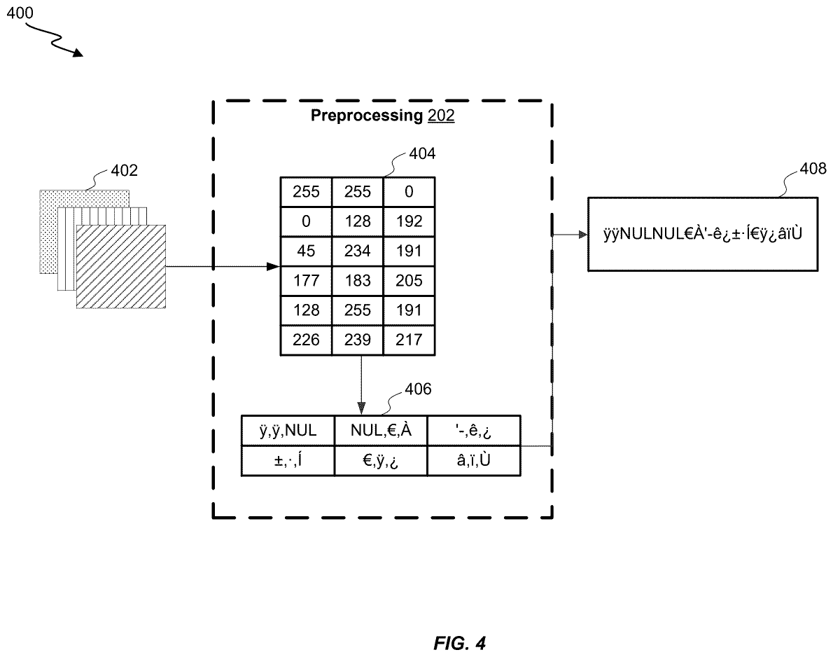

FIG. 4 illustrates an exemplary block diagram 400 showing preprocessing 202 of input data 112 including an image 402 to generate encrypted data 114 in accordance with some aspects of the present disclosure. The image 402, such as an RGB image representing the red, green, and blue color intensities of each pixel, may be extracted. These RGB values may be organized into a matrix 404 capturing the spatial structure of the image 402. Each row of the matrix may correspond to the RGB values of a specific pixel, preserving the spatial relationships of the image. For example, a pixel that appears yellow may be generated by combining red and green at equal intensities. The corresponding values in the matrix may include the RGB values such as: 255 (for red), 255 (for green), and 0 (for blue). The image 402, in the preprocessing block 202, may be treated to generate encrypted data 114 in a first digital format. For example, each value in the matrix 404 may be converted into its extended ASCII representation to form another matrix 406 translating numerical RGB values (ranging from 0 to 255) into their respective extended ASCII characters. For instance, the value 255 may correspond to the extended ASCII character ‘ÿ’ as per an extended ASCII table as ASCII ranged from 0 to 127, while the pixel values of an image may range from 0 to 255. Alternatively, the pixel values of the matrix 404 may be normalized for mapping to ASCII. The other matrix 406 may represent the pixel values in textual form, with each RGB value being converted into its extended ASCII equivalent.

The extended ASCII characters for each pixel of 3D or 2D matrix may be combined to form a string representation 408, representing the encrypted data in textual format as the first digital format. For the 3D matrix, each 2D matrix may be concatenated to form a final character-encoded vector corresponding to the string representation 408 of a colored image. The string representation (or the encrypted data) 408 may serve as a compact, serialized version of the image data, where the color information and spatial arrangement of pixels are encoded in a linear text format that may be more efficient for encryption and/or transmission over communication channels. This approach may be particularly useful when non-binary transmission methods may be used, such as network protocols or applications that involve text-based data processing. The string representation 408 may then be applied with other transformations such as numeric conversions (e.g., ASCII or binary) to be processed by the one or more machine-learning models in the subsequent modeling 206.

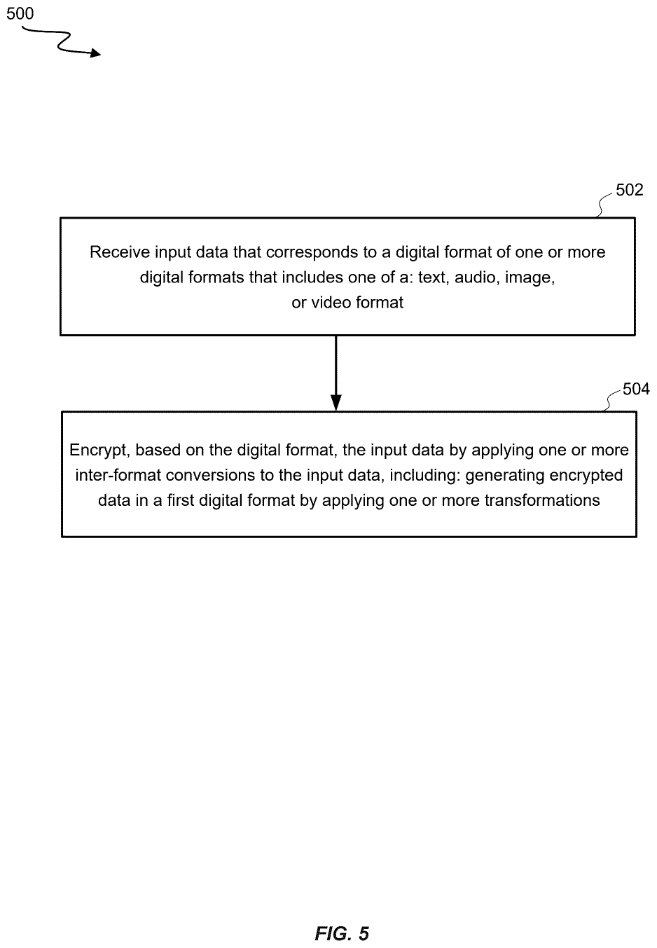

FIG. 5 illustrates an exemplary workflow 500 for the encryption of the input data in accordance with some aspects of the present disclosure. The blocks in the exemplary workflow 500 are illustrated in a specific order, while the order may be modified, for example, some blocks may be performed before others, and some blocks may be performed simultaneously. The blocks may be performed by hardware, software, or a combination thereof. For encryption, a process at block 502 may receive the input data 112 that corresponds to a digital format of the one or more digital formats (e.g., text, image, audio, or video). At block 504, the input data may be encrypted by applying one or more inter-format conversions to the input data. For example, a first inter-format conversion of the one or more inter-format conversions may include generating encrypted data 114 by preprocessing the input data 112, involving one or more transformations. These transformations may comprise a series of transformations (e.g., character-encoding, numeric-encoding, mathematical, and/or statistical transformations). Additionally, the transformations may include various vector and/or matrix operations such as vector/matrix arithmetic, reshaping, rescaling, normalization, complementing etc. Additionally, in some examples, the input data may be manipulated by incorporating a modifying parameter, prior to, during, or subsequent to the first inter-format conversion. During the first inter-format conversion, the first digital format is different from the digital format of the input data 112.

For the input data 112 including textual data, the one or more transformations may include multiple numeric conversions (e.g., inter-base conversions such as binary, octal, ASCII, hexadecimal, or a combination thereof) or a shorthand encrypted format followed by numeric conversions and reshaping to generate a matrix representation as the encrypted data. The generated 2D matrix may correspond to an image format as the first digital format. Similarly, for the input data 112 including an image, the one or more transformations may include a subsequent 1D (character-encoded) vector that corresponds to the textual format. Moreover, the encrypted data for the input data including audio data may correspond to an image or a textual format. It may be appreciated that the order of applying the one or more transformations may vary.

In some examples, the inter-format conversions may further include a second inter-format conversion of the one or more inter-format conversions, generating a secondary encrypted representation in a second digital format by modeling the encrypted data. The modeling 212 may include applying one or more machine-learning models that may be configured to generate the second digital format. The second digital format may be different from the first digital format. It may be understood that the inter-format conversions may be applied in any sequence and iteratively, for example, for text input data, the first inter-format conversion may also include text-to-audio (e.g., by applying one or more machine-learning models) and a second inter-format conversion may include audio-to-image (e.g., by applying one or more transformations or by taking an STFT). Continuing these inter-format conversions, a third inter-format conversion may include image-to-text (e.g., by applying the one or more transformations) and so on. The encrypted data 114 may be sent to the network 106 or stored in a database 118 for further processing. The encrypted data 114 may go through inter-format decryption 108 to retrieve the decrypted data 116 associated with the input data 112.

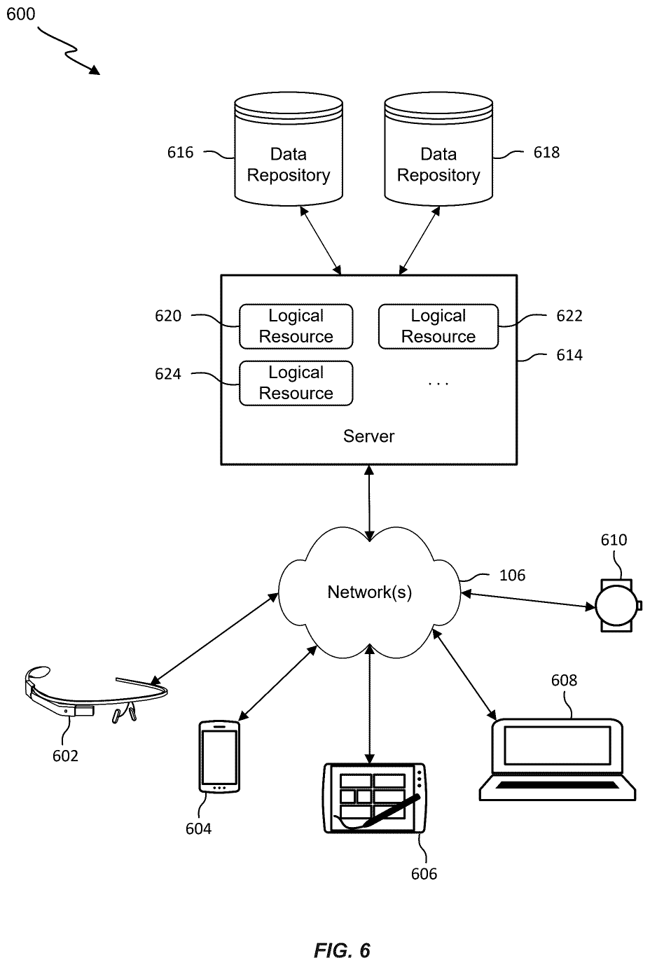

FIG. 6 depicts a simplified diagram of a distributed system 600 for implementing an embodiment. In the illustrated embodiment, distributed system 600 includes one or more client computing devices 602, 604, 606, 608, and/or 610 coupled to a server 614 via one or more communication networks. Clients computing devices 602, 604, 606, 608, and/or 610 may be configured to execute one or more applications for encrypting or decrypting data. In various aspects, server 614 may be adapted to run one or more services or software applications that enable secure data encryption and/or decryption techniques as disclosed. In certain aspects, server 614 may also provide other services or software applications that can include non-virtual and virtual environments. In some aspects, these services may be offered as web-based or cloud services, such as under a Software as a Service (SaaS) model to the users of client computing devices 602, 604, 606, 608, and/or 610. Users operating client computing devices 602, 604, 606, 608, and/or 610 may in turn utilize one or more client applications to interact with server 614 to utilize the services provided by these components.

In the configuration depicted in FIG. 6, server 614 may include one or more components 620, 622 and 624 that implement the functions performed by server 614. These components may include software components that may be executed by one or more processors, hardware components, or combinations thereof. It should be appreciated that various system configurations are possible, which may be different from distributed system 600. The embodiment shown in FIG. 6 is thus one example of a distributed system for implementing an embodiment system and is not intended to be limiting.

Users may use client computing devices 602, 604, 606, 608, and/or 610 for techniques in accordance with the teachings of this disclosure. A client device may provide an interface that enables a user of the client device to interact with the client device. The client device may also output information to the user via this interface. Although FIG. 6 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs.

Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various applications such as various Internet-related apps, communication applications (e.g., e-mail applications, short message service (SMS) applications) and may use various communication protocols.

Network(s) 106 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 106 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 614 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 614 can include one or more virtual machines running virtual operating systems, or other computing architectures involving virtualization such as one or more flexible pools of logical storage devices that can be virtualized to maintain virtual storage devices for the server. In various aspects, server 614 may be adapted to run one or more services or software applications that provide the functionality described in the foregoing disclosure.

The computing systems in server 614 may run one or more operating systems including any of those discussed above, as well as any commercially available server operating system. Server 614 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 614 may include one or more applications to analyze and consolidate data feeds and/or event updates received from users of client computing devices 602, 604, 606, 608, and/or 610. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 614 may also include one or more applications to display the data feeds and/or real-time events via one or more display devices of client computing devices 602, 604, 606, 608, and/or 610.

The distributed system 600 may also include one or more data repositories 616, 618. These data repositories may be used to store data and other information in certain aspects. For example, one or more of the data repositories 616, 618 may be used to store information for techniques disclosed herein. Data repositories 616 and 618 may reside in a variety of locations. For example, a data repository used by server 614 may be local to server 614 or may be remote from server 614 and in communication with server 614 via a network-based or dedicated connection. Data repositories 616 and 618 may be of different types. In certain aspects, a data repository used by server 614 may be a database, for example, a relational database, a container database, an Exadata® storage device, or other data storage and retrieval tools such as databases provided by Oracle Corporation® and other vendors. One or more of these databases may be adapted to enable storage, update, and retrieval of data to and from the database in response to structured query language (SQL)-formatted commands.

In certain aspects, one or more data repositories 616, 618 may also be used by applications to store application data. The data repositories used by applications may be of different types such as, for example, a key-value store repository, an object store repository, or a general storage repository supported by a file system.

In one embodiment, server 614 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices to perform the requested services and keep tenant data confidential from other tenants.

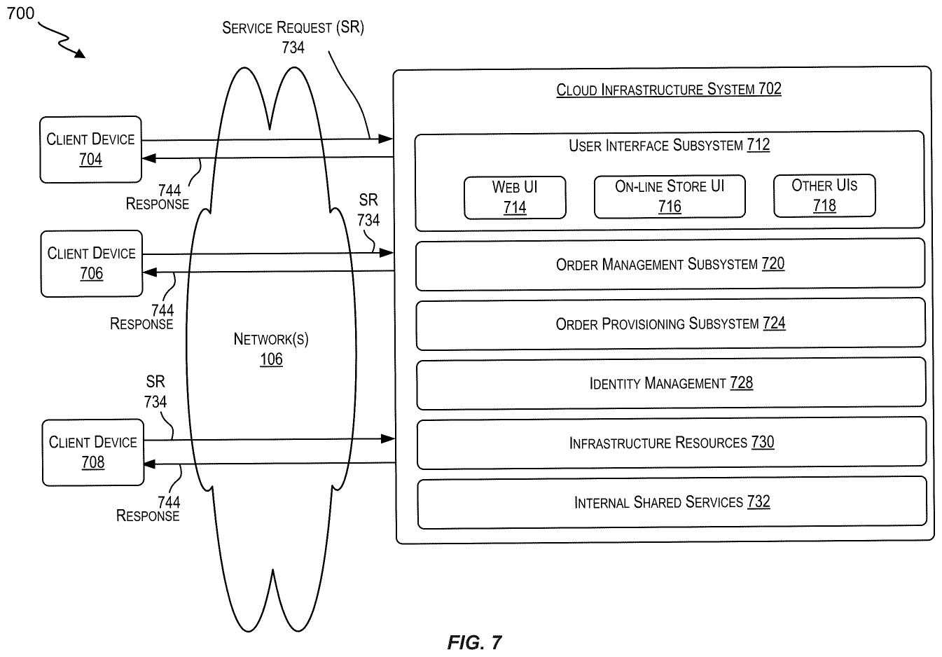

FIG. 7 is a simplified block diagram of a cloud-based system environment in accordance with certain aspects of various embodiments of the invention. In the embodiment depicted in FIG. 7, cloud infrastructure system 702 may provide one or more cloud services that may be requested by users using one or more client computing devices 704, 706, and 708. Cloud infrastructure system 702 may comprise one or more computers and/or servers that may include those described above for server 614. The computers in cloud infrastructure system 702 may be organized as general-purpose computers, specialized server computers, server farms, server clusters, or any other appropriate arrangement and/or combination.

Network(s) 106 may facilitate communication and exchange of data between clients 704, 706, and 708 and cloud infrastructure system 702. Network(s) 106 may include one or more networks. The networks may be of the same or different types. Network(s) 106 may support one or more communication protocols, including wired and/or wireless protocols, for facilitating communications.

The embodiment depicted in FIG. 7 is only one example of a cloud infrastructure system and is not intended to be limiting. It should be appreciated that, in some other aspects, cloud infrastructure system 702 may have more or fewer components than those depicted in FIG. 7, may combine two or more components, or may have a different configuration or arrangement of components. For example, although FIG. 7 depicts three client computing devices, any number of client computing devices may be supported in alternative aspects.

The term cloud service is generally used to refer to a service that is made available to users on demand and via a communication network such as the Internet by systems (e.g., cloud infrastructure system 702) of a service provider. Typically, in a public cloud environment, servers and systems that make up the cloud service provider's system are different from the cloud customer's (“tenant's”) own on-premises servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 106 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 702 may provide one or more cloud services using different models such as a Software as a Service (SaaS) model, a Platform as a Service (PaaS) model, an Infrastructure as a Service (IaaS) model, a Data as a Service (DaaS) model, and others, including hybrid service models. Cloud infrastructure system 702 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants with access to on-demand applications that are hosted by cloud infrastructure system 702. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may be searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manners. For example, a tenant, via a subscription order, may order one or more services provided by cloud infrastructure system 702. Cloud infrastructure system 702 then performs processing to provide the services requested in the tenant's subscription order. Cloud infrastructure system 702 may be configured to provide one or even multiple cloud services.

Cloud infrastructure system 702 may provide the cloud services via different deployment models. In a public cloud model, cloud infrastructure system 702 may be owned by a third-party cloud services provider and the cloud services are offered to any public tenant, where the tenant can be an individual or an enterprise. In certain other aspects, under a private cloud model, cloud infrastructure system 702 may be operated within an organization (e.g., within an enterprise organization) and services provided to clients that are within the organization. For example, the clients may be various departments or employees or other individuals of departments of an enterprise such as the Human Resources department, the payroll department, etc., or other individuals of the enterprise. In certain other aspects, under a community cloud model, the cloud infrastructure system 702 and the services provided may be shared by several organizations in a related community. Various other models such as hybrids of the above-mentioned models may also be used.

Client computing devices 704, 706, and 708 may be of different types (such as devices 602, 604, 606, and 608 depicted in FIG. 6) and may be capable of operating one or more client applications. A user may use a client device to interact with cloud infrastructure system 702, such as to request a service provided by cloud infrastructure system 702.

In some aspects, the processing performed by cloud infrastructure system 702 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 702 for determining the intent of an utterance. The data used for this analysis may include structured data (e.g., data stored in a database or structured according to a structured model) and/or unstructured data (e.g., data blobs (binary large objects)).

As depicted in the embodiment in FIG. 7, cloud infrastructure system 702 may include infrastructure resources 730 that are utilized for facilitating the provision of various cloud services offered by cloud infrastructure system 702. Infrastructure resources 730 may include, for example, processing resources, storage or memory resources, networking resources, and the like.

In certain aspects, to facilitate efficient provisioning of these resources for supporting the various cloud services provided by cloud infrastructure system 702 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 702 may internally use services 732 that are shared by different components of cloud infrastructure system 702 and which facilitate the provisioning of services by cloud infrastructure system 702. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 702 may comprise multiple subsystems. These subsystems may be implemented in software, or hardware, or combinations thereof. As depicted in FIG. 7, the subsystems may include a user interface subsystem 712 that enables users of cloud infrastructure system 702 to interact with cloud infrastructure system 702. User interface subsystem 712 may include various interfaces such as a web interface 714, an online store interface 716 where cloud services provided by cloud infrastructure system 702 are advertised and are purchasable by a consumer, and other interfaces 718. For example, a tenant may, using a client device, request (service request 734) one or more services provided by cloud infrastructure system 702 using one or more interfaces 714, 716, and 718. For example, a tenant may access the online store, browse cloud services offered by cloud infrastructure system 702, and place a subscription order for one or more services offered by cloud infrastructure system 702 that the tenant wishes to subscribe to. The service request may include information identifying the tenant and one or more services that the tenant desires to subscribe to. For example, a tenant may place a subscription order for a chatbot related service offered by cloud infrastructure system 702. As part of the order, the client may provide information identifying the input (e.g., utterances).

In certain aspects, such as the embodiment depicted in FIG. 7, cloud infrastructure system 702 may comprise an order management subsystem (OMS) 720 that is configured to process the new order. As part of this processing, OMS 720 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 720 may then invoke the order provisioning subsystem (OPS) 724 that is configured to provision resources for the order including processing, memory, and networking resources. The provisioning may include allocating resources for the order and configuring the resources to facilitate the service requested by the tenant order. The way resources are provisioned for an order and the type of the provisioned resources may depend upon the type of cloud service that has been ordered by the tenant. For example, according to one workflow, OPS 724 may be configured to determine the cloud service being requested and identify several pods that may have been pre-configured for that cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the requested tenant to provide the requested service.

Cloud infrastructure system 702 may send a response or notification 744 to the tenant to indicate when the requested service is now ready for use. In some instances, information (e.g., a link) may be sent to the tenant that enables the tenant to start using and availing of the benefits of the services requested.

Cloud infrastructure system 702 may provide services to multiple tenants. For each tenant, cloud infrastructure system 702 is responsible for managing information related to one or more subscription orders received from the tenant, maintaining tenant data related to the orders, and providing the requested services to the tenant or clients of the tenant. Cloud infrastructure system 702 may also collect usage statistics regarding a tenant's use of subscribed services. For example, statistics may be collected for storage used, the amount of data transferred, the number of users, and the amount of system up time and system down time, and the like. This usage information may be used to bill the tenant. Billing may be done, for example, on a monthly cycle.

Cloud infrastructure system 702 may provide services to multiple tenants in parallel. Cloud infrastructure system 702 may store information for these tenants, including possibly proprietary information. In certain aspects, cloud infrastructure system 702 comprises an identity management subsystem (IMS) 728 that is configured to manage tenant's information and provide the separation of the managed information such that information related to one tenant is not accessible by another tenant. IMS 728 may be configured to provide various security-related services such as identity services, such as information access management, authentication and authorization services, services for managing tenant identities and roles and related capabilities, and the like.

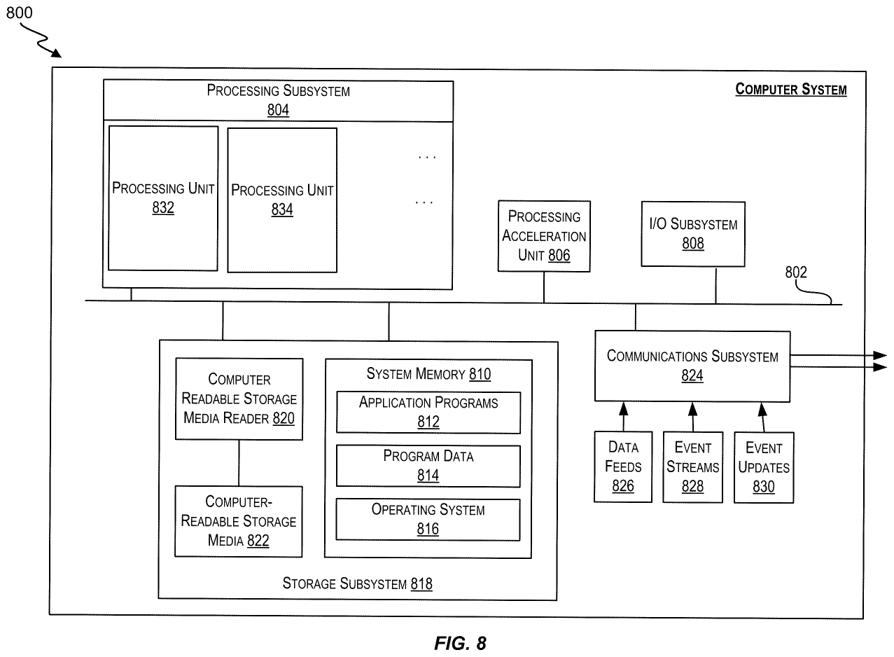

FIG. 8 illustrates an exemplary computer system 800 that may be used to implement certain aspects. As shown in FIG. 8, computer system 800 includes various subsystems including a processing subsystem 804 that communicates with several other subsystems via a bus subsystem 802. These other subsystems may include a processing acceleration unit 806, an I/O subsystem 808, a storage subsystem 818, and a communications subsystem 824. Storage subsystem 818 may include non-transitory computer-readable storage media including storage media 822 and a system memory 810.

Bus subsystem 802 provides a mechanism for letting the various components and subsystems of computer system 800 communicate with each other as intended. Although bus subsystem 802 is shown schematically as a single bus, alternative aspects of the bus subsystem may utilize multiple buses. Bus subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of computer system 800 and may comprise one or more processors, application specific integrated circuits (ASICs), or field programmable gate arrays (FPGAs). The processors may be single core or multicore processors. The processing resources of computer system 800 can be organized into one or more processing units 832, 834, etc. A processing unit may include one or more processors, one or more cores from the same or different processors, a combination of cores and processors, or other combinations of cores and processors. In some aspects, processing subsystem 804 can include one or more special purpose co-processors such as graphics processors, digital signal processors (DSPs), or the like. In some aspects, some or all the processing units of processing subsystem 804 can be implemented using customized circuits, such as application specific integrated circuits (ASICs), or field programmable gate arrays (FPGAs).

In some aspects, the processing units in processing subsystem 804 can execute instructions stored in system memory 810 or on computer readable storage media 822. In various aspects, the processing units can execute a variety of programs or code instructions and can maintain multiple concurrently executing programs or processes. At any given time, some or all the program code to be executed can be resident in system memory 810 and/or on computer-readable storage media 822 including potentially on one or more storage devices. Through suitable programming, processing subsystem 804 can provide various functionalities described above. In instances where computer system 800 executes one or more virtual machines, one or more processing units may be allocated to each virtual machine.

In certain aspects, a processing acceleration unit 806 may optionally be provided for performing customized processing or for off-loading some of the processing performed by processing subsystem 804 to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information into computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, the use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 818 provides a repository or data store for storing information and data that is used by computer system 800. Storage subsystem 818 provides a tangible non-transitory computer-readable storage medium for storing the basic programming and data constructs that provide the functionality of some aspects. Storage subsystem 818 may store software (e.g., programs, code modules, instructions) that when executed by processing subsystem 804 provides the functionality described above. The software may be executed by one or more processing units of processing subsystem 804. Storage subsystem 818 may also provide a repository for storing data used in accordance with the teachings of this disclosure.

Storage subsystem 818 may include one or more non-transitory memory devices, including volatile and non-volatile memory devices. As shown in FIG. 8, storage subsystem 818 includes a system memory 810 and a computer-readable storage media 822. System memory 810 may include several memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 800, such as during start-up, may typically be stored in the ROM. The RAM typically contains data and/or programming modules that are presently being operated and executed by processing subsystem 804. In some implementations, system memory 810 may include multiple different types of memory, such as static random-access memory (SRAM), dynamic random-access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 822 may store programming and data constructs that provide the functionality of some aspects. Computer-readable media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, digital video disc (DVD), a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magneto-resistive RAM (MRAM) SSDs, and hybrid SSDs that use a combination of DRAM and flash memory based SSDs.

In certain aspects, storage subsystem 818 may also include a computer-readable storage media reader 820 that can further be connected to computer-readable storage media 822. Reader 820 may receive and be configured to read data from a memory device such as a disk, a flash drive, etc.

In certain aspects, computer system 800 may support virtualization technologies, including but not limited to virtualization of processing and memory resources. For example, computer system 800 may provide support for executing one or more virtual machines. In certain aspects, computer system 800 may execute a program such as a hypervisor that facilitates the configuring and managing of the virtual machines. Each virtual machine may be allocated memory, computer (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices. For example, the communications subsystem may be used to transmit a response to a user regarding the inquiry for a chatbot.

Communications subsystem 824 may support both wired and/or wireless communication protocols. For example, in certain aspects, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 824 can provide wired network connectivity (e.g., Ethernet) in addition to or instead of a wireless interface.

Communications subsystem 824 can receive and transmit data in various forms. For example, in some aspects, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to communicate data from computer system 800 to other computer systems or networks. The data may be communicated in various forms such as structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation, such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specifications and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

Potentially claimable subject matter includes, but is not limited to:

1. A computer-implemented method including:
receiving input data that corresponds to a digital format of one or more digital formats that includes one of a: text, audio, image, or video format; and
encrypting, based on the digital format, the input data by applying one or more inter-format conversions on the input data, including:
generating encrypted data in a first digital format by applying one or more transformations to the input data, wherein the one or more transformations include numeric-encoding, character-encoding, arithmetic operations, statistical transformation or a shorthand transformation, and wherein the first digital format is different from the digital format of the input data.

2. The computer-implemented method of claim 1, wherein the encryption of the input data by applying the one or more inter-format conversions further including:
generating, based on the first digital format, a secondary encrypted representation in a second digital format of the one or more digital formats by modeling the encrypted data, wherein the modeling includes applying one or more machine-learning models configured to map the first digital format to the second digital format that is different from the first digital format.

3. The computer-implemented method of claim 2, wherein the one or more machine-learning models include an encoder configured to generate the encrypted data.

4. The computer-implemented method of claim 1, further including:
progressively applying a modifying parameter to each inter-format conversion of the one or more inter-format conversions, wherein the modifying parameter is applied arithmetically.

5. The computer-implemented method of claim 1, wherein the encrypted data is generated independent of any encryption key.

6. The computer-implemented method of claim 1, further comprising:
generating decrypted data that corresponds to the input data by applying one or more reverse transformations to the encrypted data.

7. The computer-implemented method of claim 6, wherein the decrypted data is generated independent of any decryption key.

8. A system comprising:
one or more data processors; and
a non-transitory computer readable storage medium containing instruction which, when executed on the one or more data processors, cause the one or more data processors to perform a set of operations including:
receiving input data that corresponds to a digital format of one or more digital formats that includes one of a: text, audio, image, or video format; and
encrypting, based on the digital format, the input data by applying one or more inter-format conversions on the input data, including:
generating encrypted data in a first digital format by applying one or more transformations to the input data, wherein the one or more transformations include numeric-encoding, character-encoding, arithmetic operations, statistical transformation or a shorthand transformation, and wherein the first digital format is different from the digital format of the input data.

9. The system of claim 8, wherein the encryption of the input data by applying the one or more inter-format conversions further including:
generating, based on the first digital format, a secondary encrypted representation in a second digital format of the one or more digital formats by modeling the encrypted data, wherein the modeling includes applying one or more machine-learning models configured to map the first digital format to the second digital format that is different from the first digital format.

10. The system of claim 9, wherein the one or more machine-learning models includes an encoder configured to generate the encrypted data.

11. The system of claim 8, further including:
progressively applying a modifying parameter to each inter-format conversion of the one or more inter-format conversions, wherein the modifying parameter is applied arithmetically.

12. The system of claim 8, wherein the encrypted data is generated independent of any encryption key.

13. The system of claim 8, further comprising:
generating decrypted data that corresponds to the input data by applying one or more reverse transformations to the encrypted data.

14. The system of claim 13, wherein the decrypted data is generated independent of any decryption key.

15. A computer-program product tangibly embodied in a non-transitory machine readable storage medium, including instructions configured to cause one or more data processors to perform to perform a set of operations comprising:
receiving input data that corresponds to a digital format of one or more digital formats that includes one of a: text, audio, image, or video format; and
encrypting, based on the digital format, the input data by applying one or more inter-format conversions on the input data, including:
generating encrypted data in a first digital format by applying one or more transformations to the input data, wherein the one or more transformations include numeric-encoding, character-encoding, arithmetic operations, statistical transformation or a shorthand transformation, and wherein the first digital format is different from the digital format of the input data.

16. The computer-program product of claim 15, wherein the encryption of the input data by applying the one or more inter-format conversions including:
generating, based on the first digital format, a secondary encrypted representation in a second digital format of the one or more digital formats by modeling the encrypted data, wherein the modeling includes applying one or more machine-learning models configured to map the first digital format to the second digital format that is different from the first digital format.

17. The computer-program product of claim 16, wherein the one or more machine-learning models include an encoder configured to generate the encrypted data.

18. The computer-program product of claim 15, further including:
progressively applying a modifying parameter to each inter-format conversion of the one or more inter-format conversions, wherein the modifying parameter is applied arithmetically.

19. The computer-program product of claim 15, wherein the encrypted data is generated independent of any encryption key.

20. The computer-program product of claim 15, further comprising:
generating decrypted data that corresponds to the input data by applying one or more reverse transformations to the encrypted data, wherein the decrypted data is generated independent of any decryption key.
